(19) United States
(12) Patent Application Publication
(10) Pub. No.: US 2008/0194175 A1
(43) Pub. Date: Aug. 14, 2008

(54) Interactive toy providing, dynamic, navigable media content

(75) Inventors: Michael D. Last, New York, NY (US); Alexander Davidov, Brooklyn, NY (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Intellitoys LLC

(21) Appl. No.: 12/068,509

(22) Filed: Feb. 7, 2008

Related U.S. Application Data
(60) Provisional application No. 60/900,521, filed on Feb. 9, 2007.

(51) Int. Cl. A63H 3/28; G06F 3/048

(52) U.S. Cl. 446/302; 715/716

(57) ABSTRACT

A media player device is disclosed. The media player device has at least one input device configured to receive input from a user of the media player device and to generate a signal indicative of the input; a communication interface configured to selectively connect the media player device to a device separate from the media player device; and a processor in communication with the at least one input device and the communication interface. The processor may be configured to establish a communication channel between the media player device and the separate device when the media player device is selectively connected to the separate device; to receive at least one selected media content item from the separate device through the communication channel; to present an announcement describing content of the at least one selected media content item; and to prompt a user of the media content device to select whether to execute the at least one selected media content item. The processor may be further configured to receive input, via the at least one input device, indicating whether to execute the at least one selected media content item and to execute the at least one selected media content item when the input indicates that the at least one media content item is to be played.

### CROSS REFERENCE

This application is based upon and claims the benefit of priority from U.S. Provisional Application No. 60/900,521 filed on Feb. 8, 2007, the entire contents of which are incorporated herein by reference.

### TECHNICAL FIELD

The present disclosure relates generally to toys and, more particularly, to an interactive toy providing dynamic, navigable media content.

### BACKGROUND INFORMATION

Developers of children's toys are continually trying to create products that provide a more enjoyable, educational, interactive, or engaging experience for the child. Toward this end, toys, such as plush toys, have been developed that provide a variety of routines and/or features.

One such toy is disclosed in U.S. Pat. No. 6,463,257 issued to Wood (the '257 patent). The '257 patent disclosed a plush toy that includes a plurality of indicia (e.g., buttons) on its surface. When the child pushes a button, the toy plays a recording. For example, when a song button is pressed, the toy plays a randomly selected song. In another example, if the child pushes a green circle button, the toy announces that the green circle has been pressed.

While the toy of the '257 patent may entertain the child at least for a while, it cannot be customized. That is, like other existing toys, the toy's functionality cannot be modified, changed, or removed. Thus, the child may grow bored with the toy's functions rather quickly. In addition, because the toy's functions are elementary and directed to children of a very young age, the child will quickly outgrow the toy.

This disclosure is directed to overcoming one or more of the problems associated with existing toys.

### SUMMARY

One aspect of the disclosure is directed to a media player device. The media player device may include at least one input device configured to receive input from a user of the media player device and to generate a signal indicative of the input; a communication interface configured to selectively connect the media player device to a device separate from the media player device; and a processor in communication with the at least one input device and the communication interface. The processor may be configured to establish a communication channel between the media player device and the separate device when the media player device is selectively connected to the separate device; to receive at least one selected media content item from the separate device through the communication channel; to present an announcement describing content of the at least one selected media content item; and to prompt a user of the media content device to select whether to execute the at least one selected media content item. The processor may be further configured to receive input, via the at least one input device, indicating whether to execute the at least one selected media content item; and to execute the at least one selected media content item when the input indicates that the at least one media content item is to be played.

Another aspect of the disclosure is directed to a method of navigating media content. The method may include receiving, by a media player device, at least one selected media content item from a device separate from the media playing device; presenting, by the media player device, an announcement describing content of the at least one selected media content item; and prompting a user of the media player device to select whether to execute the at least one selected media content item. The method may further include receiving, by the media player device, input indicating whether to execute the at least one selected media content item and executing, by the media player device, the at least one selected media content item when the input indicates that the at least one selected media content item is to be executed.

Another aspect of the disclosure is directed to a computing system. The computing system may include at least one input device and a processor in communication with the at least one input device. The processor may receive, via the at least one input device, a selection of at least one of media content item; identify at least one supplemental media content item associated with the selected at least one media content item, the supplemental media content item including an announcement describing content of the at least one media content item; and create a playlist containing the selected at least one media content item and the identified at least one supplemental media content item.

Yet another aspect of the disclosure is directed to a computer-implemented method of managing media content. The method may include receiving a selection of at least one media content item; identifying at least one supplemental media content item associated with the selected at least one media content item, the supplemental media content item including an announcement describing content of the selected at least one media content item; and creating a playlist containing the selected at least one media content item and the identified at least one supplemental media content item.

Still yet another aspect of the disclosure is directed to a toy. The toy may include a plush body; an internal processor associated with the plush body; a memory device associated with the plush body and configured to communicate with the internal processor and to store a plurality of media content items, the plurality of media content items including at least a first media content item and a second media content item; an audio speaker associated with the plush body and configured to generate sound as a result of signals from the internal processor; an input device associated with the plush body configured to receive input from a user of the toy and to generate a corresponding input signal; a communication interface associated with the internal processor and configured to selectively connect the internal processor to an external device outside of the plush body; an application associated with the internal processor for receiving media content items from the external device and for storing the received media content items in the memory device; an application associated with the internal processor for providing an audible message for announcement to the user of the toy through the audio speaker, the audible message prompting the user of the toy to select the first media content item; and an application associated with the internal processor for receiving input through the input device indicative of the user of the toy's selection of the first media content item; and an application associated with the internal processor for providing an audible message for announcement to the user of the toy through the audio speaker, the audible message prompting the user of the toy to select the second media content item when the first media content item is not selected.

### BRIEF DESCRIPTION OF THE DRAWINGS

FIG. 1 shows a representation of an exemplary interactive toy environment in which the present disclosure may be implemented;

FIG. 2 shows a representation of an exemplary server for use in the interactive toy environment of environment of FIG. 1;

FIG. 3 shows a representation of an exemplary client for use in the interactive toy environment of environment of FIG. 1;

FIG. 4 shows a representation of an exemplary graphical user interface application (GUI) for use with the client of FIG. 3;

FIG. 5 shows a representation of an exemplary playlist file created by the GUI of FIG. 4;

FIG. 6 shows a representation of an exemplary interactive toy for use in the interactive toy environment of FIG. 1; and

FIG. 7 shows a flowchart depicting exemplary processing by the interactive toy of FIG. 6.

### DETAILED DESCRIPTION OF PREFERRED EMBODIMENTS

Reference will now be made in detail to the exemplary preferred embodiments implemented according to the disclosure, non-limiting examples of which are illustrated in the accompanying drawings. The same reference numbers are used throughout the drawings to refer to the same or like parts.

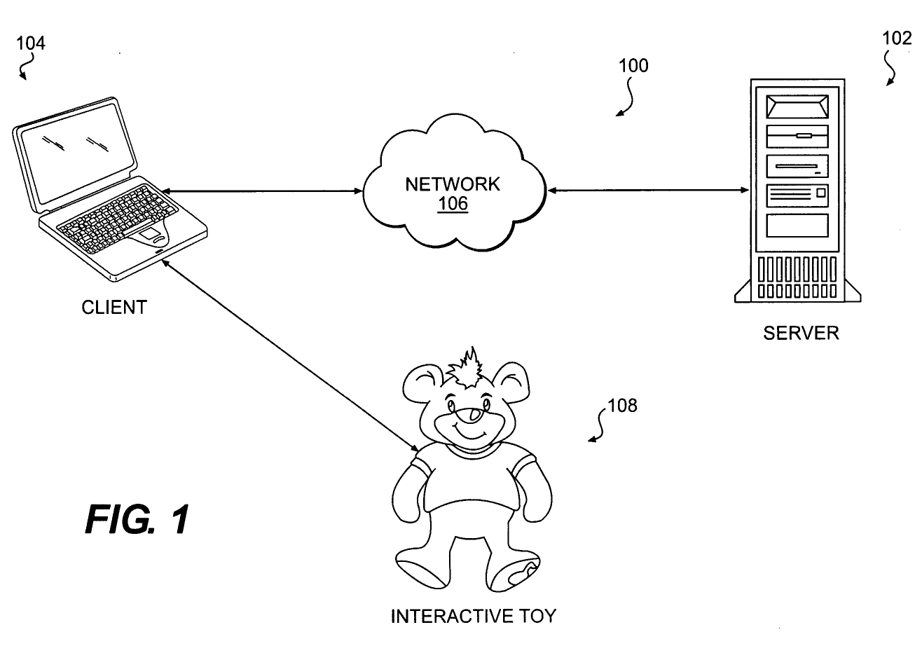

FIG. 1 shows an exemplary interactive toy environment 100 in which the present disclosure may be implemented. Environment 100 may include a server 102 and one or more clients 104 in communication via network 106 (e.g., the Internet, an intranet, or another suitable packet-switched network). Client 104 may also be configured to communicate with an interactive toy 108.

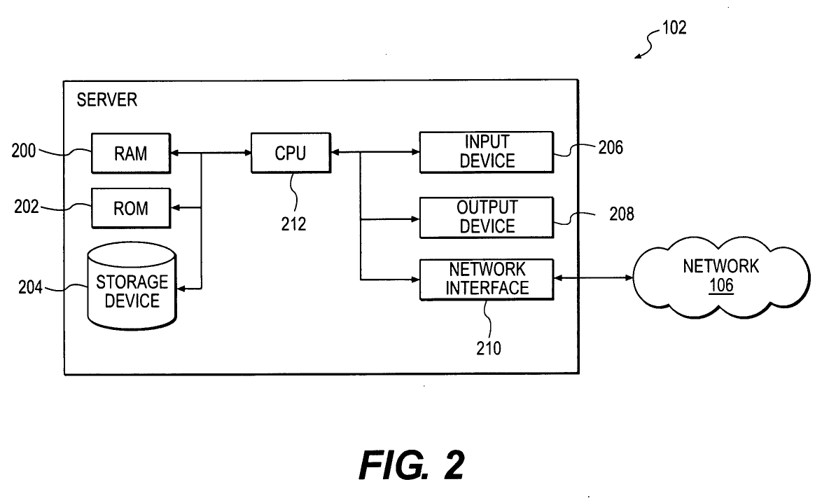

Referring to FIG. 2, server 102 may be associated with an entity that allows client 104 to purchase and download media content. Server 102 may include any type of processor-based system on which processes and methods consistent with the disclosed embodiments may be implemented. For example, server 102 may be desktop or laptop computer, one or more designated server computers connected via a network, or any other suitable server computer system owned or otherwise controlled by an entity (e.g., a company that licenses and/or sells downloadable media content).

Server 102 may include hardware and/or software components configured to execute programs. For instance, server 102 may include hardware components such as random access memory (RAM) 200, read-only memory (ROM) 202, a storage device 204, an input device 206, an output device 208, and a network interface 210, each in communication with a central processing unit (CPU) 212. One or more of the hardware components listed above may alternatively or additionally be implemented using software, if desired. For example, storage device 204 may include a software partition associated with one or more other hardware components of server 102. Server 102 may include additional, fewer, and/or different components than those listed above, as the components listed above are exemplary only and not intended to be limiting.

RAM 200 and ROM 202 may include a device for storing information associated with operations of client 104 and CPU 212. RAM 200 may include a memory device for storing data associated with one or more operations of CPU 212. For example, instructions from ROM 202 may be loaded into RAM 200 for execution by CPU 212. ROM 202 may include a memory device configured to access and store information associated with server 102, including information for identifying, initializing, and monitoring the operation of one or more components of server 102.

Storage device 204 may include any type of mass storage device configured to store information that CPU 212 uses perform processes consistent with the disclosed embodiments. For example, storage device 204 may include one or more magnetic disk drives (e.g., hard drives); one or more optical disk drives (e.g., CD-ROMs, DVD-ROMs); flash or other computer-readable media storage drives; and/or any other type of mass media storage device.

Storage device 204 may contain, among other things, a library of proprietary and/or non-proprietary media content items available for downloading by client 104 and uploading to interactive toy 108 for execution. In certain embodiments, the content and subject matter of the media content items may be educational, recreational, or otherwise appealing and engaging to children.

For instance, the media content items may include audio files, e.g., Vorbis (OGG), MP3, WAV, MC, AIFF, WMA, etc., which can be played by interactive toy 108. In one embodiment, the audio files may include children's music focused on a variety of themes, e.g., nursery rhymes, lullabies, storybook songs, animal songs, dancing songs, number songs, songs by children's artists, etc. The audio files may also include non-music content such as stories (e.g., bedtime stories), books on tape, voices, sounds, etc.

The media content items may also include video or audio-video hybrid files, e.g., MPG, WMV, AVI, etc., that may be played by interactive toy 108. Like the audio files, the video files may be directed to subject matter engaging to children, e.g., cartoons, lessons, music videos, TV shows, etc.

The media content items may further include applications and/or programs that may uploaded to, and executed by, interactive toy 108, e.g., EXE files, CPP files (C++), etc. In one aspect, the applications and/or programs may be directed to games (e.g., Simon Says), lessons (e.g., language lessons, math lessons, etc.), quizzes, and/or other activities that invite participation from the child.

Alternatively or additionally, the library may further include supplemental media content items that may be executed by interactive toy 108, such as greetings (e.g., “Hello, Cindy!”); exclamations (e.g., laughter); announcements (e.g., “Would you like to listen to songs about animals?” Or, “would you like to listen to the song “Monkey Business?””); prompts (e.g., “For “yes,” squeeze may hand. For “no,” squeeze my foot.””); and/or other supplemental content that may be used in conjunction with the media content items. The supplemental media content items will be discussed in further detail below.

The media content items contained in storage may include and/or otherwise be associated with information that enables the media content items to be classified, identified, described, and/or otherwise organized. In one embodiment, the information may comprise metadata including one or more fields of information describing one or more characteristics of the media content items (e.g., each media content item may include or be associated with a unique metadata tag). The fields may be directed to, for example, a name or title of the media content item; the author or artist of the media content item; the type of the content item (e.g., music, story, game, book, announcement, lesson, Spanish lesson, etc.); the theme of the media content item (e.g., nursery rhymes, animals, monkeys, bedtime stories, lullabies, etc.); the album in which the media content item is included; a playlist with which the media content item is associated; a profile with which the media content item is associated; a length of the media content item; a storage size of the media content item; a time and/or date at which the media content item ought to be executed (e.g., a holiday, naptime, bedtime, learning time, etc.); and/or any other suitable information that can be used to classify or organize media content items. In some embodiments, the metadata may include multiple classifications per metadata field. For example, a song may be both a song about animals and a Christmas song (e.g., the “theme” field may be set to =“Animals, Christmas”).

In addition, the supplemental media content items mentioned above (e.g., greetings, announcements, prompts, etc.) may similarly include and/or be associated with such metadata. For example, an audio file including an announcement that recites “Would you like to listen to songs about animals?” may have metadata linking the announcement to media content items having the metadata fields “type” =“music” and “theme” =“animals.” In another example, an audio file including an announcement that recites “I'm getting sleepy. How about you?” may have metadata linking the announcement to media content items having the metadata field “theme” =“bedtime.” In this manner, server 102, client 104 and/or interactive toy 108 may determine with which media content items the supplemental media content items are to be associated. These associations may be used by client 104 and interactive toy 108 to present the media content to a child in a dynamic, navigable manner, which will be further discussed below.

The exemplary media content items provided above are intended to be illustrative in nature, rather than limiting. It is to be appreciated that storage device 204 may contain any type of media content items directed to any type of subject matter that might be appealing, educational, or otherwise attractive to children of all ages.

Storage device 204 may also contain information about customers of the entity in control of server 102—that is, users of client 104 that purchase and download media content items from server 102. For example, storage device 204 may have an account for each customer of the entity (e.g., a customer account database). The account may include an account number; user names; email addresses; passwords; pin numbers; credit cards and/or other financial accounts to be charged for purchase of media content items; billing addresses; customer contact information; subscription information (e.g., the presence or absence of a particular subscription enabling the customer to download media content items); content licensing information (e.g., a listing of media content items the customer has previously purchased and downloaded); and/or other suitable information for maintaining a customer account.

Input device 206 may include any device configured to receive input from a user and to provide an input command signal to CPU 212 in response to the input. Input device 206 may include, for example, a keyboard, a mouse, a touch pad, a touch screen, a microphone and/or any other user interface device configured receive user input for a computer system.

Output device 208 may include any device configured to receive an output command signal from CPU 212 and to convey information to the user of client 104 in response to the command. Output device 208 may include, for example, include a display device (e.g., a CRT display, an LCD display, a plasma display, etc.), a printer, a speaker, and/or any other user interface devices suitable for providing output to a user of a computer system.

Network Interface 210 may include one or more components configured to transmit and receive data via network 106. Network interface 310 may include and/or otherwise be associated with appropriate network architecture (not shown) to facilitate such communication. The network architecture may include, alone or in any suitable combination, modulators, demodulators, multiplexers, demultiplexers, antennas, modems, gateways, routers, and/or any other devices configured to enable data communication via a communication network, e.g., a telephone-based network (such as PBX or POTS), a local area network (LAN), a wide area network (WAN), a dedicated intranet, a workstation peer-to-peer network, a direct link network, a wireless network, etc.

CPU 212 may include one or more processors configured to execute instructions and to process data to perform one or more functions associated with client 104. For example, CPU 212 may be configured to execute sequences of computer program instructions to perform one or more processes, which will be described in detail below. The computer program instructions may be loaded into RAM 200 for execution by CPU 212. The instructions, when executed, may cause CPU 212 to run a media content management application to interface between client 104 and server 102 via network 106. The media content management application may facilitate communications between server 102 and client 104 by, among other things, performing communication protocol conversion operations on messages sent to and/or received from network 106; authenticating a user at client 104 requesting access to server 102; granting or denying access to server 102 (e.g., based on account information); transferring media content from server 102 to client 104; performing firewall operations; and/or performing other server operations.

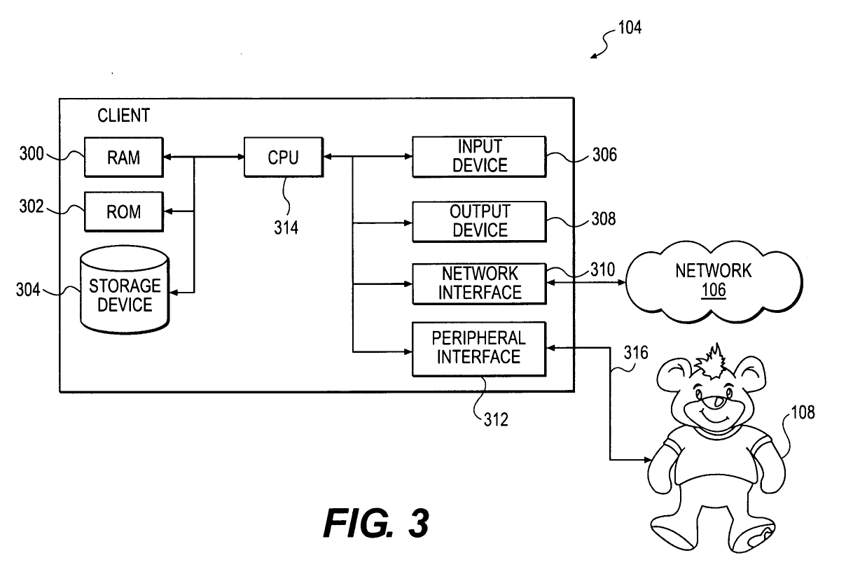

Referring to FIG. 3, client 104 may be a platform including any type of processor-based system on which processes and methods consistent with the disclosed embodiments may be implemented. Client 104 may be, for example, a desktop or laptop computer, a personal digital assistant (PDA), a hand-held computer (e.g., a Pocket PC), a cellular telephone, or another computing system known in the art.

Like server 102, client 104 may include components configured to execute software programs. For example, client 104 may include hardware components such as a random access memory (RAM) 300, read-only memory (ROM) 302, a storage device 304, an input device 306, an output device 308, a network interface 310, and a peripheral interface 312 in communication with a central processing unit (CPU) 314. One or more of the hardware components listed above may alternatively or additionally be implemented using software, if desired. For example, storage device 304 may include a software partition associated with one or more other hardware components of client 104. Client 104 may include additional, fewer, and/or different components than those listed above, as the components listed above are exemplary only and not intended to be limiting.

RAM 300 and ROM 302 may include a device for storing information associated with operations of client 104 and CPU 314. RAM 300 may include a memory device for storing data associated with one or more operations of CPU 314. For example, instructions from ROM 302 may be loaded into RAM 300 for execution by CPU 314. ROM 302 may include any memory device configured to access and to store information associated with client 104, including information for identifying, initializing, and monitoring the operation of one or more components of client 104.

Storage device 304 may include any type of mass storage device configured to store information that CPU 314 may use to perform processes consistent with the disclosed embodiments. For example, storage device 304 may include one or more magnetic and/or optical disk devices, such as hard drives, CD-ROMs, DVD-ROMs, or any other type of mass media device. Storage device 304 may contain, among other things, a library of media content items previously purchased and downloaded from server 102 by a user of client 104. Storage device 304 may further include playlists and profiles containing media content items and/or other information for execution by interactive toy 108, which will be discussed in further detail below.

Input device 306 may include any device configured to receive input from a user and to provide an input command signal to CPU 314 in response to the input. Input device 306 may include, for example, a keyboard, a mouse, a touch pad, a touch screen, a microphone and/or any other user interface device configured receive user input for a computer system.

Output device 308 may include one or more components configured to receive an output command signal from CPU 314 and to convey information to the user of client 104 in response to the command. Output device 308 may include, for example, include a display device (e.g., a CRT display, an LCD display, a plasma display, etc.), a printer, a speaker, and/or any other user interface device configured to provide output to a user of a computer system.

Network Interface 310 may include one or more components configured to transmit and to receive data via network 106. Network interface 310 may include and/or otherwise be associated with appropriate network architecture (not shown) to facilitate such communication. The network architecture may include, alone or in any suitable combination, one or more modulators, demodulators, multiplexers, demultiplexers, antennas, modems, gateways, routers, and/or any other devices configured to enable data communication via a communication network, e.g., a telephone-based network (such as PBX or POTS), a local area network (LAN), a wide area network (WAN), a dedicated intranet, a workstation peer-to-peer network, a direct link network, a wireless network, etc.

Peripheral interface 312 may include any device configured to communicatively couple interactive toy 108 to client 104 via a peripheral data link 316. For instance, peripheral interface 312 may be an IEEE 1394 (FireWire®) port, a Universal Serial Bus (USB) port, an Ethernet port, or another port suitable for connecting a peripheral device to a computer. Accordingly, peripheral data link 316 may be a USB cable, a FireWire® cable, an Ethernet cable, or another suitable cable, respectively.

In a case where peripheral interface 312 is an Ethernet port, client 104 may communicate with interactive toy 108 directly or via a local network (not shown), e.g., a local area network (LAN), a wide area network (WAN), etc. Alternatively or additionally, peripheral interface 312 may include a wireless communication device enabling direct or indirect communication between client 104 and interactive toy 108 using one or more wireless protocols (e.g., IEEE 802.11 or another WiFi protocol, Bluetooth®, etc.).

CPU 314 may include one or more processors configured to execute instructions and to process data to perform one or more functions associated with client 104. For example, CPU 314 may be configured to execute sequences of computer program instructions to perform one or more processes, which will be described in detail below. The computer program instructions may be loaded into RAM 300 for execution by CPU 314.

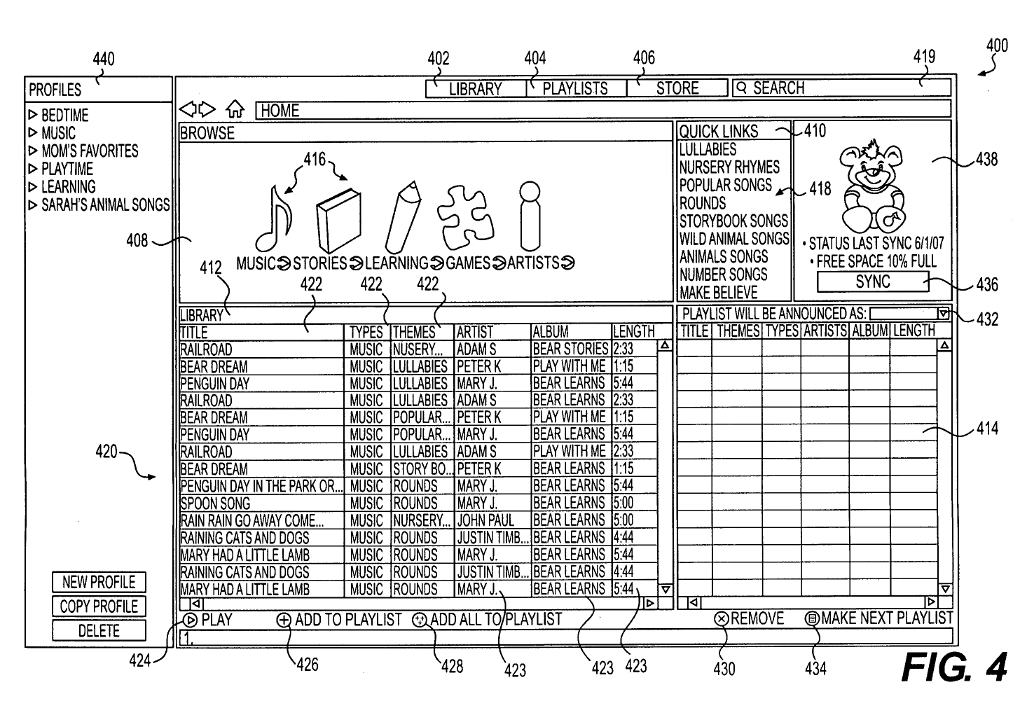

FIG. 4 shows an exemplary graphical user interface application (GUI) 400 that may be executed by client 104. GUI 400 may be displayed to a user at client 104 via output device(s) 308 and process input from the user via input device(s) 306. In particular, GUI 400 may allow a user at client 104 to purchase and to download media content from server 102 onto client 104. GUI 400 may also enable the user to upload the downloaded media content to interactive toy 108; to create playlists of media content items to be played by interactive toy 108; to create profiles containing media content items to be played by, and instructions for configuration of, interactive toy 108; and/or to otherwise manage a library of media content items to be used with interactive toy 108. These features will be discussed in further detail below.

For purposes of subsequent discussion, it may be assumed that the user of GUI 400 is a parent, older sibling, relative, teacher, a family friend, or another person in a trusted role to a child in possession of interactive toy 108. It is to be appreciated, however, that the user may be any person trusted to manage the media content items and the configuration of interactive toy 108 for the child.

GUI 400 may be a software tool including menus (e.g., drop-down menus), modules, buttons, toolbars, functions and/or other means to facilitate the processes disclosed herein. It is to be appreciated that GUI 400 may require user authentication, such as, for example, a username, a password, and/or a pin number, etc. As shown by FIG. 4, GUI 400 may include a library mode button 402, a playlists mode button 404, and a store mode button 406.

The user may select library mode button 402 to create one or more playlists for uploading to interactive toy 108 from the user's library of previously purchased and downloaded media content items in storage device 304. As used herein, “playlist” may refer to a customized selection or list of one or more media content items to be played and/or executed by interactive toy 108 in a particular order. The media content items in a playlist may be chosen by the user and focused on a particular theme, mood, genre, type, artist, etc.

Upon selection of library mode button 402, GUI 400 may display or update one or more library browser windows 408 and 410, a library listing window 412, and a playlist creation window 414.

Library browser window(s) 408 and 410 may include a plurality of media content selection entries 416 and 418 corresponding to metadata associated with the media content items contained in the user's library on storage device 304. Entries 416 and 418 may identify and/or otherwise be associated with a particular metadata field of the media content items. That is, each of entries 416 and 418 may correspond to a different type, theme, genre, etc., of the media content items.

As shown in FIG. 4, in one embodiment, entries 416 in library browser window 408 may correspond to broad categories such as, for example, music, stories, learning, games, artists, etc. On the other hand, entries 418 in library browser window 410 may correspond to more specific categories within the broad categories of library browser window 408. For example, in the case of music, as shown in FIG. 4, entries 418 may correspond to lullabies, nursery rhymes, wild animal songs, etc. While entries 416 and 418 are shown in FIG. 4 as icons and textual entries, respectively, it is to be appreciated that entries 416 and 418 may alternatively or additionally embody any other visual indicator suitable for conveying information about the media content items in an intuitive fashion. In addition, arrangements other than library browser windows 408 and 410 may be used, if desired.

Selection of one of entries 416 may cause GUI 400 to update library listing window 412 with the media content items in the user's library having metadata of the “category” corresponding to the selected entry (e.g., “type” =“music”). In addition, GUI 400 may update browser window 410 with entries 418 corresponding to media content items in the user's library having metadata of specific “subcategory” (e.g., “theme” =“animals”) within the overall category of the selected one of entries 416 (i.e., “type” =“music”). Likewise, the user may further select a desired one of entries 418 (“Animal Songs”), which may cause GUI 400 to further update library listing window 412 as to display only those media content items having metadata corresponding to the selected one of entries 418.

GUI 400 may accomplish this by, for example, searching and/or filtering the metadata of the media content items in the user's library according to the “categories” and/or “subcategories” of the selected entries 416 and 418. The resulting media content items 420 may then be displayed in library listing window 412. Alternatively or additionally, the user may enter text into search field 419, which may be used by GUI 400 to search and/or filter the metadata of the media content items in the user's library.

In one embodiment, library listing window 412 may include regions 422 containing metadata associated with media content items 420 (e.g., rows, columns, etc.). For example, each of regions 422 may correspond to a different metadata field 423 of media content items 420. In the example shown in FIG. 4, regions 422 correspond to the title, type, artist, album, and length of media content items 420. These examples, however, are intended to be illustrative rather than limiting. Additional, fewer, and/or different regions 422 corresponding to different metadata fields 423 may alternatively or additionally be displayed. In addition, the user may edit metadata fields 423 by clicking or otherwise selecting a desired metadata field and entering a new description. Further, the regions 422 that are displayed may be selectable or otherwise configurable by the user.

Library listing window 412 may include or be associated with, for instance, a play button 424, an add to playlist button 426, and an add all to playlist button 428. Selection of play button 424 may cause GUI 400 to play a selected one of media content items 420. For example, the user may wish to sample a particular media content item before adding it to a playlist and uploading it to interactive toy 108. As such, the user may click with the mouse or otherwise select a desired one of media content items 420 (e.g., “Mary Had a Little Lamb”). The user may then click play button 424 to cause GUI 400 to play the selected media content item through a speaker (not shown) connected to client 104.

The user may also select media content items 420 from library listing window 412 to create a playlist for uploading to interactive toy 108. The playlist may be shown in playlist creation window 414. For example, the user may use the mouse to click on or otherwise select one or more of media content items 420. The user may then click add to playlist button 424 to add the selected media content items to playlist creation window 414. Similarly, the user may use add all to playlist button 428 to add all of the media content items 420 shown in library listing window 412 to playlist creation window 414. Alternatively or additionally, the user may use mouse gestures, e.g., selective highlighting, “drag-and-drop,” or the like, to add media content items 420 to playlist creation window 414.

Once the desired media content items are in playlist creation window 414, the user may arrange the order of the media content items therein using, for example, mouse gestures (e.g., “drag-and-drop”) or the like. In addition, the user may remove unwanted media content items from playlist creation window 414 using remove button 430. Specifically, the user may use the mouse to click on or otherwise select one or more unwanted media content items from playlist creation window 414. The user may then select remove button 430 to remove the selected items from playlist creation window 414. Alternatively or additionally, the user may use mouse gestures, e.g., selective highlighting, “drag-and-drop,” or the like, to remove unwanted media content items from playlist creation window 414.

During or after creating a playlist, GUI 400 may determine one or more appropriate tags, or names, for the playlist. Specifically, GUI 400 may compare the associated metadata of the media content items in playlist creation window 414 and identify which, if any, share common values (e.g., type, artists, theme, etc.). GUI 400 may then generate one or more appropriate tags for the media content items using the identified common values. For example, if multiple media content items in playlist creation window 414 have the metadata fields “type” =“song” and “theme” =“animals” in common, one tag generated by GUI 400 may be “songs about animals.” In one embodiment, GUI 400 may place the playlist tags thus generated in drop-down menu 432 or another suitable location for selection by the user. Thus, the user may gauge the relative appropriateness of the playlist tags generated by GUI 400 for the collection of media content items selected for the playlist (i.e., in playlist creation window 414).

In one embodiment, depending on the metadata of the media content items in the playlist (i.e., in playlist creation window 414), the generated playlist tags may be hierarchical in nature. For example, if two or more media content items have the metadata field “theme” =“animals” and “monkeys,” GUI 400 may generate a specific playlist tag for the two or more media content items, such as “songs about monkeys,” because “monkeys” is a subset of “animals.” In contrast, if one media content item has the metadata field “theme” =“animals” and “monkeys” and another media content item having the metadata field “theme” =“animals” and “bears,” GUI 400 may generate a generic playlist tag for the media content items, such as “songs about animals.” Such playlist tags may be included for the user's selection in drop-down menu 432. It is to be appreciated, however, that GUI 400 may generate potential playlist tags using any other methods known in the art.

In one aspect, the playlist tags thus generated may correspond to the supplemental media content items contained in the user's library and discussed above. For example, the exemplary playlist tag “Songs about Animals” may be linked to, or otherwise associated with, an audio file announcing the playlist (e.g., “Would you like to listen to songs about animals?”). In other words, the playlist tag selected from drop-down menu 432 may indicate the manner in which the content of the playlist (i.e., the items in playlist creation window 414) will be announced and presented to the child by interactive toy 108.

If GUI 400 is unable to generate an appropriate tag for the collection, GUI 400 may, for example, generate a default playlist tag of the most general type (e.g., “Songs”), which may also be listed for selection in drop down menu 432. In one embodiment, if the user finds the playlist tags generated by GUI 400 to be unacceptable or inappropriate, the user may assign another tag to the playlist using drop down menu 432.

Once the user is satisfied with the playlist—that is, the listing of media content items in playlist creation window 414 and the selected playlist tag from drop-down menu 432—the user may create subsequent playlists in the same manner by selecting make next playlist button 434. At this point, GUI 400 may store the playlist thus created in the user's library on storage device 304 for future reference. For instance, GUI 400 may generate and store a playlist file (e.g., playlist1.txt) indicating the order of the media content items, the selected playlist tag, and/or any other appropriate information about the playlist.

Selection by the user of the playlists mode button 404 may cause GUI 400 to display another screen (not shown) allowing the user to view and/or edit existing playlists. For instance, the user may be able to add, remove, and/or change the ordering of media content items of previously-created playlists. In addition, the user may be able to create new playlists in the manner discussed above. Further, the user may be able to upload selected playlists to interactive toy 108.

The user may select store mode button 406 to purchase and to download additional media content items from the entity. For example, GUI 400 may display another screen (not shown) allowing the user to navigate through the media content contained on server 102 (i.e., in the media content library on storage device 204). Navigation through the media content on server 102 may be affected in the same or a similar manner to the navigation discussed above in connection with library browser windows 408 and 410 and search field 419.

The user may select one or more desired media content items, playlists, profiles, etc., to download. The user may then purchase (e.g., using a credit card) or agree to purchase the selected items. GUI 400 may then post a charge to the user's account and initiate downloading of the items to client 104. The downloaded items may then be added to the user's library on storage device 304. At this point, the user may be free to use the downloaded media content items, playlists, and/or profiles for uploading to interactive toy 108.

In one embodiment, GUI 400 may also include feature (not shown) allowing the-user to record media content items using a microphone associated with client. For example, the user may read and record a bedtime story, a message, or the like. The user may then select and assign metadata to the recording (e.g., “artist” =“mom,” “type” =“story,” “theme” =“bedtime,” etc.) The recording may then be added to the user's library. Alternatively or additionally, the user may call a phone number associated with the entity (e.g., a 1-800 number), and server 102 may record the message via the phone after the user enters a correct account number, password, pin number, etc. The recording may be made available to the user for downloading the next time the user accesses GUI 400.

GUI 400 may also include an interactive toy synch button 436. When interactive toy 108 is successfully connected to client 104, the user's selection of synch button 436 may cause GUI 400 to synchronize, or update, interactive toy 108, provided enough storage space is available. The synchronization may be achieved through comparison by GUI 400 of the media content on interactive toy 108 and the media content in the user's library on storage device 304. When the comparison indicates that a particular media content item, playlist, or profile is resident in the user's library but not on interactive toy 108, the item may be transmitted to interactive toy 108 via peripheral data link 316. On the other hand, when the comparison indicates that a particular media content item, playlist, or profile is resident on interactive toy 108 but not in the user's library, the item may either be removed (i.e., deleted), transmitted via peripheral data link 316 to client 104 for storage in the user's library, or otherwise rendered inactive.

The user may also be able to upload individual selected playlists to interactive toy 108 after selecting playlists mode button 404. For example, the user may click on or otherwise select one or more desired playlists in the user's library for uploading, add the selected playlists to a window listing the playlists to be transferred to interactive toy 108, and then click a button (not shown) to cause GUI 400 to transfer the playlists to interactive toy 108.

An interactive toy status window 438 may display status information about interactive toy 108, e.g., an image of interactive toy 108, a name of interactive toy 108, an amount of available storage space on interactive toy 108, the time and/or date that interactive toy 108 was last “synched” by GUI 400 (i.e., one or more playlists were last uploaded to interactive toy 108), and/or other information about interactive toy 108. This information may be gathered by GUI 400 upon connecting interactive toy 108 to client via peripheral data link 316.

GUI 400 may further include a profile creation feature 440. A profile may be a “container” including one or more playlists and one or more configuration settings to set operation modes of interactive toy 108. For example, a profile may include one “songs about animals” playlist, one playlist containing bedtime stories, one playlist containing Spanish lessons, and one playlist containing games. The profile may also include configuration settings that control the behavior of interactive toy 108. The configuration settings may indicate, for example, a playback mode of interactive toy 108 (e.g., “shuffle” or “interactive”), a volume (e.g., “2”) a difficulty level (e.g., “easy”), an interaction level of interactive toy 108 (e.g., “high”) a time of day during which one or more of the playlists should be played (e.g., the bedtime story playlist may be played at or after 7 pm), and/or other configuration settings for interactive toy 108.

Profile creation feature 440 may allow the user to create a profile by selecting one or more playlists from the user's library and assigning such configuration settings to the playlist(s) and/or the overall profile. Profile creation feature 440 may also allow the user upload a profile to interactive toy 108. A profile may be stored in the user's library and on interactive toy 108 as a file (e.g., an EXE file) that may be recognized and executed by interactive toy 108.

When one or more playlists are transferred to interactive toy 108, GUI 400 may transfer more than just the media content items of the playlists themselves. For example, GUI 400 may transfer, among other things, the metadata of the media content items and associated supplemental media content items (discussed above) allowing interactive toy 108 to present, prompt, or otherwise convey the metadata (and the associated media content) to the child.

In one embodiment, each different instance of metadata may be associated, based on common metadata, with a supplemental audio file (e.g., an OGG or MP3 file). As such, each media content item may be associated with one or more supplemental media content items, as a media content item may have multiple fields of metadata. For instance, an audio file of a song entitled “Monkey Business” (e.g., “title” =“Monkey Business”) may be associated with one supplemental audio file that announces the title of the song (e.g., “Would you like to listen to the song “Monkey Business”?”); one supplemental audio file that announces the type (e.g., “type” =“animals”) of the song (e.g., “Would you like to listen to songs about animals?”); one supplemental audio file that announces the artist (e.g., “artist” =“John Smith”) of the song (e.g., “Would you like to listen to songs by John Smith?”); and/or other similar announcements.

Additionally, each media content item may include or otherwise be associated with an audio file that may be used by interactive toy 108 to announce the completion of a playlist containing the media content item (e.g., “Great job! You finished songs about animals!” Or, “Great Job! You've finished songs by John Smith!”). Thus, one or more of these supplemental media content items may be added by GUI 400 to the playlist prior to transferring the playlist to interactive toy 108 (e.g., upon selection from drop-down menu 432 of a desired playlist tag). In this manner, interactive toy 108 may present the content in a manner that allows the child to navigate through the content, which will be discussed below.

As used herein, an “announcement” may correspond to any manner in which a media content item may be introduced or otherwise conveyed to a user of interactive toy 108 for purposes of selection, media content navigation, etc. As such, an announcement may take any form suitable for conveying the content or subject matter of a media content item to a user of interactive toy (e.g., an audio file, a video file, a program, etc.).

Such supplemental media content items may be automatically downloaded from server 102 along with associated media content items. For example, continuing with the example above, if the user purchases and downloads the song “Monkey Business,” additional associated supplemental audio files announcing the name of the song (e.g., “Would you like to listen to the song “Monkey business?””); the type of the song (e.g., “Would you like to listen to songs about animals?”); the artist of the song (e.g., “Would you like to listen to songs by John Smith?”); etc. may also be downloaded and linked to the song in the user's library. When a particular item is purchased and downloaded, GUI 400 may compare the user's library with that of the server to identify and download any of these associated supplemental media content items that are not present in the user's library.

Alternatively or additionally, instead of transferring such audio announcements, GUI 400 may simply transfer associated text string announcements (e.g., “Would you like to listen to the song “Monkey Business?””) and interactive toy 108 may be configured to convey the text string announcements as audible speech using, for example, a text-to-speech application.

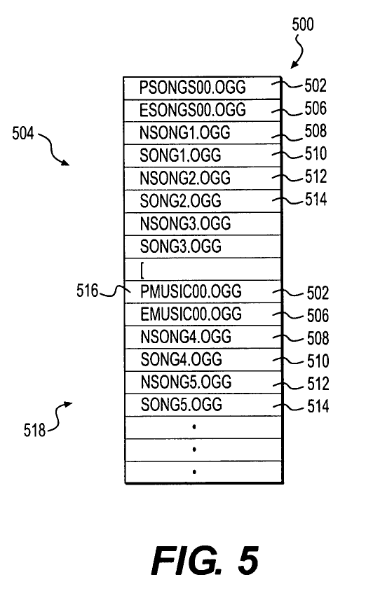

FIG. 5 shows a representation of an exemplary playlist file 500 as uploaded to interactive toy 108 (alone or as part of a profile) along with the associated media content items, metadata, and other media items discussed above. Playlist file 500 may be generated by GUI 400 prior to, or while, uploading content to interactive toy 108 (e.g., after synch button 436 is selected). Playlist file 500 may essentially be a “table of contents” allowing interactive toy 108 to identify the media content items associated with a particular playlist, the order in which the media content items should be played, and/or other appropriate information. In one embodiment, playlist file 500 may be a text file or another type of file suitable for indicating to interactive toy 108 the content and arrangement of a playlist. It is to be appreciated that playlist file 500 may describe a single or multiple playlists, if desired. That is, GUI 400 may generate and/or update a single playlist file 500 for all of the playlists uploaded to interactive toy 108, or a separate playlist file 500 for each playlist.

Referring to FIG. 5, a first entry 502 in playlist file 500 may reference an audio file (e.g., “PSONGS00.OGG”) announcing the name (i.e., tag) of a first playlist 504 (e.g., “Would you like to listen to songs about animals?”). A second entry 506 in playlist file 500 may reference an audio file (e.g., “ESONGS00.OGG”) announcing completion of playlist 504 (e.g., “Great job! You've finished songs about animals!”). A third entry 508 in playlist file 500 may reference an audio file (e.g., “NSONG1.OGG”) announcing the name of the first media content item in playlist 504 (e.g., “Would you like to listen to the song “Monkey Business?””). A fourth entry 510 in playlist file 500 may reference the actual file (e.g., “SONG1.OGG”) that is first media content item (i.e., the song itself) in playlist 504. Similarly, a fifth entry 512 in playlist file 500 may reference an audio file (e.g., “NSONG2.OGG”) announcing the name of the second media content item in playlist 504 (e.g., “Would you like to listen to “The Safari Song?””), and a sixth entry 514 in playlist file 500 may reference the actual file (e.g., “SONG2.OGG”) that is the second media content item (i.e., the song itself) in playlist 504. Playlist file 500 may continue in this manner, depending on the number of media content items in playlist 504. Playlist file 500 may also include a delineator 516, e.g., a particular textual character or the like, which may separate first playlist 504 from another playlist 518 contained in playlist file 500. It is to be appreciated that playlist 518 may have a format similar to that of playlist 504. Playlist file 500 may continue in this manner depending on the number of playlists therein. In a case where interactive toy 108 has text-to-speech capability, one or more of entries 502, 506, 508, 512, etc., may be text strings, and interactive toy 108 may convert the text to speech, as discussed above.

While the foregoing describes GUI 400 as being implemented by client 104, other embodiments are contemplated. For instance, GUI 400 may be a web application or the like executed by server 102 and provided to client 104 via network 106. That is, at least some of the GUI functionality described above may be carried out by server 102 (or another computing system), rather than client 104. In such an embodiment, client 104 may be a “lightweight” terminal having, with respect to the processes disclosed herein, only the software required to perform functions not performed by the server 102. For example, a web application running on server 102 may perform all of the library, playlist, and profile functions discussed above, and client 104 may simply serve as an interface, or a portal, between server 102 and interactive toy 108 (i.e., client 104 may provide only the connectivity operations discussed above). In this manner, the media content items, playlist files, profiles, etc., may be transferred from server 102 to interactive toy 108 through client 104.

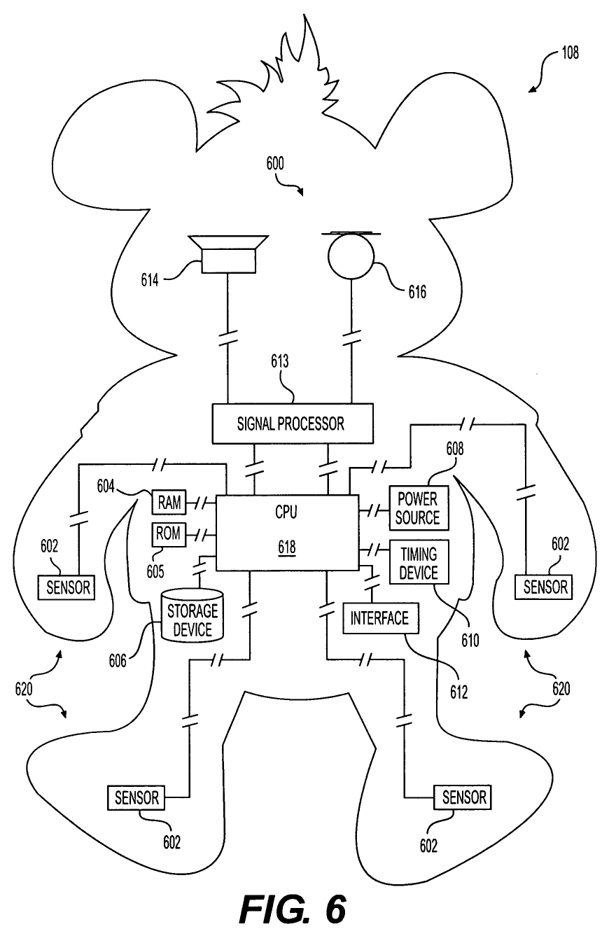

FIG. 6 shows an exemplary representation of interactive toy 108. In one embodiment, interactive toy 108 may include a plush body, a soft body, or a cuddly body, e.g., a stuffed animal or another soft figure attractive to children. Interactive toy 108 may be made of a soft, colorful fabric that is soothing to the touch. It is to be appreciated, however, that interactive toy 108 may be any type of toy attractive to children of any age (e.g., a toy truck, a guitar, etc.).

Interactive toy 108 may be equipped with a media player device 600 onfigured to carry out the processes disclosed herein. Media player device 600 may be operable to, among other things, communicatively connect interactive toy 108 to client 104; to receive and/or acquire media content from client 104; and/or to execute the media content as to entertain, engage, educate, and/or otherwise interact with the child.

Media player device 600 may include, among other features, one or more sensors 602, random access memory (RAM) 604, read-only memory (ROM) 605, a storage device 606, a power source 608, a timing device 610, an interface 612, a signal processor 613, a speaker 614, and/or a microphone 616 in communication with a central processing unit (CPU) 618. It is to be appreciated that RAM 604, ROM 605, storage device 606, and CPU 618 may be similar in structure and/or function to their counterparts discussed above in connection with server 102 and client 104. Further, one or more of the above-listed elements of media player device 600 may be integrated into a single integrated circuit, such as an application-specific integrated circuit (ASIC) or the like.

Sensors 602 may be, for example, pressure-sensitive switches, buttons, accelerometers, and/or other devices configured to receive tactile or other physical input and generate a signal indicative of the input. Sensors 602 may be disposed at or near appendages 620, extremities (e.g., hands, feet, nose, etc.), and/or other accessible locations about interactive toy 108 to facilitate intuitive interaction with the child. The signal generated by sensors 602 may be communicated to CPU 618 for subsequent processing.

Storage device 606 may, for example, a flash drive, a hard drive, or another mass storage device. Storage device 606 may contain, among other things, information relating to media content items uploaded to interactive toy 108 from client 104. Specifically, storage device 606 may contain a library of media content items, one or more playlist files (e.g., playlist file 500 of FIG. 5), one or more profiles, and/or any other information required to present the media content to the child. CPU 618 may leverage storage device 606 to perform the processes disclosed herein.

Power source 608 may include one or more batteries configured to power the elements of media player device 600. Power source 608 may comprise, for example, a lithium-ion battery power cell, one or more individual batteries (e.g., three AAA batteries), and/or any other portable or removable power source. Interactive toy 108 may include a housing (not shown) configured to accommodate, electrically connect, and secure power source 608 to interactive toy 108. Alternatively or additionally, interactive toy 108 may include a fixed power source (not shown), e.g., an A/C adapter connectable to a wall outlet, suitable for powering media player device 600.

Timing device 610 may be a digital- or analog-type device configured to monitor the time, day, and/or date. Timing device 610 may also determine an amount of time elapsed since interactive toy 108 has been powered on, an amount of time interactive toy 108 has been idle (e.g., since a button was last pressed), and/or any other similar time measurements. Timing device 610 may generate one or more signals indicative of these time determinations and send these signals to CPU 618 for subsequent processing.

Interface 612 may be any device configured to communicatively connect interactive toy 108 to client 104 via peripheral data link 316. In one embodiment, interface 612 may be a port configured to receive a peripheral cable connectable to client 104. For instance, interface 612 may be an IEEE 1394 (FireWire®) port, a Universal Serial Bus (USB) port, an Ethernet port, or another port suitable for connecting a peripheral device to a computer. In a case where interface 612 is a bus interface (e.g., USB) or another interface capable of drawing power from a host (i.e., client 104), CPU 618 may be configured to draw power from the host to power operations of media player device 600. For example, the drawn power may be used to charge power source 608 and/or power other devices of media player device 600. Alternatively or additionally, interface 612 may include a wireless link configured to communicate with client 104 directly or through a network (e.g., a LAN and/or the Internet) using one or more wireless protocols (e.g., IEEE 802.11 or another WiFi protocol).

Upon detecting a connection between interactive toy 108 (i.e., interface 612) and client 104 (i.e., peripheral interface 312) and/or receiving an appropriate instruction signal from client 104, interactive toy 108 may enter a mass storage mode. In addition, a communication channel between client 104 and interactive toy 108 may be established allowing data to read from and/or written to storage device 606 by client 104.

Signal processor 613 may be any device configured to perform analog-to-digital (A to D) signal conversion, digital-to-analog (D to A) signal conversion, filtering, amplification, attenuation, equalization, and/or other signal processing operations. For instance, signal processor 613 may receive encoded digital signals from CPU 618 (e.g., playback of a media content item), convert the digital signals to corresponding analog signals for output by speaker 614. Likewise, signal processor 613 may receive an electrical analog signal from microphone 616 and covert the analog signal into a corresponding digital signal for output to CPU 618.

Speaker 614 may be any electromechanical transducer device configured to receive an analog electrical input signal and produce a corresponding audible output signal in response thereto (e.g., a loudspeaker, headphones, etc.). Likewise, microphone 616 may be any electromechanical transducer device configured to receive an audible input signal and generate a corresponding electrical output signal in response thereto.

CPU 618 may include one or more processors configured to execute instructions and to process data to perform one or more functions associated with interactive toy 108. For example, CPU 618 may be configured to execute sequences of computer program instructions to perform various process, which will be described in detail below. The computer program instructions may be loaded into RAM 605 for execution by CPU 618. CPU 618 may be configured to, among other things, execute a media player application to play media content items stored in storage device 606; perform text-to-speech and voice-recognition operations; and/or execute other applications.

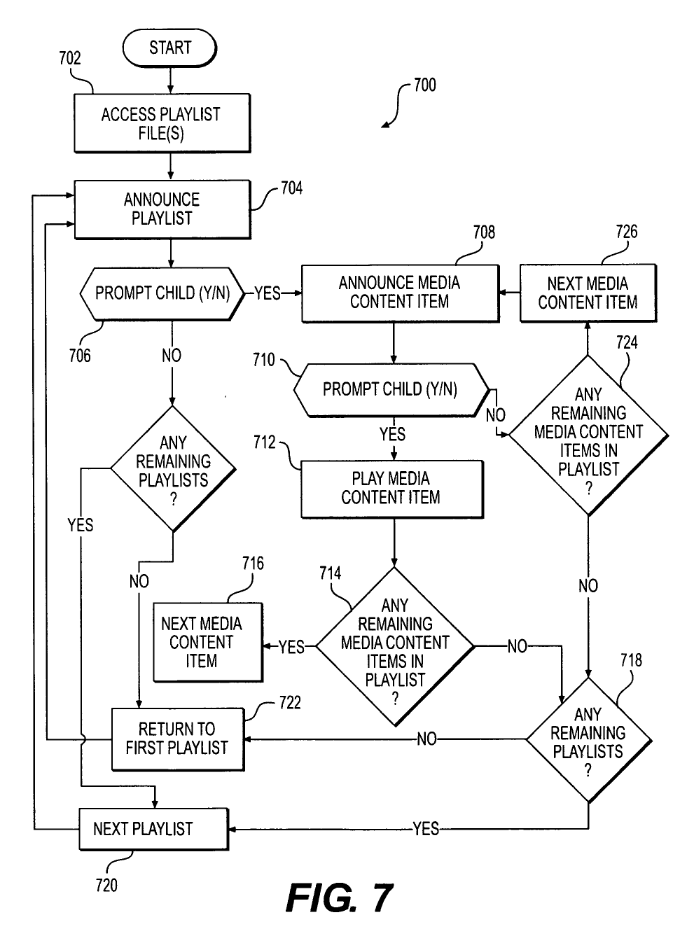

FIG. 7 shows an exemplary process 700 that may be executed by interactive toy 108 to present media content to the child. At some point after interactive toy 108 is turned on (e.g., one of sensors 602 is squeezed), CPU 618 may access, execute, and/or otherwise load from storage device 606 and/or ROM 605 one or more files to configure interactive toy 108 for operation. For example, CPU 618 may run an executable file (e.g., “PROFILE1.EXE”) to configure settings of interactive toy 108. CPU 618 may then access one or more of the playlist files contained in storage device 606 (e.g., exemplary playlist file 500 discussed above in connection with FIG. 5) (step 702).

CPU 618 may then announce the name of the first playlist in the playlist file (step 704). Particularly, CPU 618 may read the name of the first item contained in the playlist file (e.g., entry 502, “PSONGS00.OGG”). CPU 618 may then retrieve from storage device 606, and load into RAM 604, the first item (i.e., “PSONGS00.OGG”). CPU 618 may then play the first item through speaker 614. As a result, interactive toy 108 may announce the name of the first playlist (e.g., “Would you like to hear songs about animals?”). Alternatively, CPU 618 may utilize a text-to-speech application to “read” from the playlist file the text comprising the name of the first playlist to the child, as mentioned above.

CPU 618 may then prompt the child as to whether he or she would like to play (e.g., listen to) the first media content item in the playlist (step 706). Specifically, CPU 618 may load into RAM 604 a predetermined prompt file from storage device 606 (e.g., “YESNO.OGG”). CPU 618 may then play the prompt file through speaker 614. As a result, interactive toy may speak the prompt to the child (e.g., “For “yes,” squeeze my hand. For “no,” squeeze my foot.””). CPU 618 may then wait for input to one of sensors 602 from the child. If no response is received within a predetermined amount of time, CPU 618 may repeat the prompt, move on to the next playlist, or move on to the first media content item in the playlist. The child may select “yes” by providing tactile input to the appropriate one of sensors 602 (e.g., squeezing the hand). Alternatively or additionally, the child may speak “yes,” and CPU 618 may use speech recognition software interpret the child's vocalization.

If the child opts in step 706 to play the first playlist (i.e., chooses “yes”), CPU 618 may announce the name of the first media content item in the playlist (step 708). Specifically, CPU 618 may read the name of the second item contained in the playlist file (e.g., entry 508, “NSONG1.OGG”)—that is, the announcement of the media content item. CPU 618 may then retrieve from storage device 606, and load into RAM 604, the media content item (i.e., “NSONG1.OGG”). CPU 618 may then play the media content item through speaker 614. As a result, interactive toy 108 may announce the name of the first media content item in the playlist (e.g., “Would you like to listen to the song ”Monkey Business?””). In another embodiment, CPU 618 may utilize a text-to-speech application to “read” to the child the text comprising the name of the first media content item. In yet another embodiment, interactive toy 108 may include a display (not shown), and the announcement may be conveyed visually to the child via the screen (i.e., a textual display, a video, etc.).

CPU 618 may then prompt the child as to whether he or she would like to play (e.g., listen to) the first media content item in the playlist, as discussed above in connection with step 706 (step 710). If the child responds in the affirmative, CPU 618 may play the media content item (step 712). Particularly, continuing with the example discussed above, CPU 618 may read the name of the media content item in the playlist file (e.g., entry 510, “SONG1.OGG”). CPU 618 may then retrieve from storage device 606, and load into RAM 604, the media content item (i.e., “SONG1.OGG”). CPU 618 may then play the first item through speaker 614, as discussed above. Continuing with the example above, CPU 618 may play the song “Monkey Business” through speaker 618. If, however, the media content item were instead an application or a program, such as a game (e.g., Simon Says) or a lesson (e.g., a language lesson), playback of the media content item may entail both audio output to speaker and tactile and/or vocal input from the child to one or more of sensors 602 and/or microphone 616, respectively.

Upon completion of playback of the media content item in step 712, CPU 618 may determine whether there are further media content items in the playlist (step 714). CPU 618 may determine that the end of a playlist has been reached when the next item in the playlist file (e.g., playlist file 500 in FIG. 5) is a delineator (e.g., delineator 516 in FIG. 5).

If CPU 618 determines in step 714 that the playlist includes additional media content items, CPU 618 may step to the next item in the playlist file (e.g., entry 512 of playlist 504 in FIG. 5) and continue processing as discussed above in connection with step 708 (step 716). If, however, CPU 618 determines in step 714 that the playlist includes no further media content items, CPU 618 may determine whether there are any further playlists referenced in the playlist file (step 718). If so, CPU 618 may step to the next playlist in the playlist file (e.g., entry 502 of playlist 518 in FIG. 5) and continue processing as discussed above in connection with step 704 (step 720). During step 720, CPU 618 may optionally load from storage device 606, and execute, a closing audio prompt indicating that the playlist has been completed (e.g., “Great job! You've finished songs about animals!”), if desired.

If, however, CPU 618 determines in step 718 that there are no remaining playlists in the playlist file, CPU 618 may step back to the first playlist in the playlist file (e.g., entry 502 of playlist 504 in FIG. 5) (step 722), and continue processing as discussed above in connection with step 704.

If the child indicates in step 710 that he or she does not want to play the first media content item in the playlist (i.e., the song “Monkey Business,” mentioned above), CPU 618 may determine whether there are any remaining media content items in the playlist, as discussed above in connection with step 714 (step 724). If so, CPU 618 may step to the next item in the playlist file (e.g., entry 512 of playlist 504 in FIG. 5) (step 726) and continue processing as discussed above in connection with step 708. If, however, CPU 618 determines in step 724 that there are no remaining media content items in the playlist, CPU 618 may continue processing as discussed above in connection with step 718.

Thus, the invention may include, for example, applications in CPU 618, in associated memory, or in associated processors for receiving media content items from an external device and for storing the received media content items in a memory device; for providing an audible message for announcement to a user of a toy through an audio speaker, the audible message prompting the user of the toy to select the first media content item; for receiving input through an input device indicative of the user of the toy's selection of a first media content item; and for providing an audible message for announcement to the user of the toy through the audio speaker, the audible message prompting the user of the toy to select a second media content item when the first media content item is not selected.

By way of example only, these applications may include routines and/or instructions executed by the processor(s) to carry out the functions of receiving media content items from an external device and for storing the received media content items in a memory device; providing an audible message for announcement to a user of a toy through an audio speaker, the audible message prompting the user of the toy to select the first media content item; receiving input through an input device indicative of the user of the toy's selection of a first media content item; and for providing an audible message for announcement to the user of the toy through the audio speaker, the audible message prompting the user of the toy to select a second media content item when the first media content item is not selected.

In the foregoing discussion, CPU 618 has been described as incrementally stepping through the media content items in a playlist, and stepping to the next playlist upon exhausting all the media content items in the previous playlist. It is to be appreciated, however, that CPU 618 may implement other methods of navigating through the media content items and/or the playlists. For example, CPU 618 may track the number of times the child plays and/or skips the media content items and/or the playlist, as to determine which are the child's favorites. This information may be stored on storage device 606 and associated with the playlist files for reference by CPU 618. In this manner, during the processing 700 discussed above in connection with FIG. 7, CPU 618 may alternatively or additionally present the media content items and/or the playlists according to the child's preferences (e.g., the more favored media content items and/or playlists first). As such, as the child becomes bored with, and, as a result, skips particular media content items and/or playlists, CPU 618 may phase out these media content items and/or playlists in favor of lesser-played ones.

Configuration settings contained in a loaded profile may effect the processing 700 discussed above. For instance, if the profile contains information indicating that a particular playlist (e.g., bedtime stories) is to be played at a predetermined time of day (e.g., after 7 pm), CPU 618 may automatically jump to the particular playlist at the predetermined time of day. For example, in the case of a bedtime playlist, CPU 618 may automatically load and execute an audio file introducing and/or announcing the bedtime playlist at 7 pm (e.g., “I'm getting tired, how about you?”). Processing may then continue as discussed above.

In addition, the child may be able to interrupt and skip playback of a media content item (e.g., a song or game) by tactile input to one or more of sensors 602 at any point during the processing 700 discussed above. For example, if one or more of sensors 602 are activated (e.g., the child squeezes the hands or feet of interactive toy 108) a predetermined amount of times (e.g., 5 times) within a predetermined period of time (e.g., 10 seconds), CPU 618 may prompt the child as to whether he or she would like to skip to another media content item in the playlist and/or to another playlist altogether, as discussed above.

Further, a parent of the child (or another person) may cause interactive toy 108 to enter an options mode at any point during the processing 700 discussed above. For example, if CPU 618 detects a predetermined input pattern or gesture (e.g., one or more of sensors 602 are squeezed and held for 4 seconds), CPU 618 may cause interactive toy 108 to enter an options menu.

CPU 618 may present the options to the parent (or other person) in the same way as discussed above in connection with the media content items in processing 700. That is, navigation through the options menu may be similar to the navigation through the media content discussed above.

For instance, CPU 618 may retrieve from storage device 606, and load into RAM 604, a predetermined audio file announcing a menu option (e.g., “Would you like to change the volume?”). CPU 618 may then load and execute an audio file prompting the parent (or other user) as to whether the option should be changed (e.g., “For “yes,” squeeze my hand. For “no,” squeeze my foot.”). If the parent (or other user) responds affirmatively, CPU 618 may allow the option to be changed (e.g., “For “louder,” squeeze my hand. For “softer,” squeeze my foot.”). CPU 618 may then wait to detect input from the parent (or other user) indicating that the option should be changed, and change the option in response to the input. If the parent (or other user) responds negatively to the first option (e.g., volume), CPU 618 may step to the next option (e.g., changing the play mode) and prompt the parent (or other user) in a similar fashion.

The disclosed systems and methods may provide for a dynamic, interactive experience for a child. Interactive toy 108 may be periodically connected to a computer and updated with a variety of media content from a library of songs, stories, games, educational lessons, videos, and/or other types of media. Thus, interactive toy 108 may be customized to the preferences of each parent and/or child. In addition, interactive toy 108 may continually “learn” new material and routines as time goes on. Further, children of all ages may navigate through the variety of content contained on interactive toy 108 to select the content of their choice, because interactive toy 108 can interactively announce the media content to the child and prompt the child as to whether the content should be played.

Those skilled in the art will appreciate that all or part of systems and methods consistent with the present disclosure may be stored on or read from other computer-readable media having stored thereon machine executable instructions for performing, among other things, the methods disclosed herein. Exemplary computer readable media may include secondary storage devices, like hard disks, floppy disks, and CD-ROM; or other forms of computer-readable memory, such as read-only memory (ROM) or random-access memory (RAM). Such computer-readable media may be included by or embodied in one or more components of environment 100, such as server 102, client 104, interactive toy 108, and/or combinations of these and other components.

Furthermore, one skilled in the art will also realize that the processes illustrated in this description may be implemented in a variety of ways and include other modules, programs, applications, scripts, processes, threads, or code sections that may all functionally interrelate with each other to provide the functionality described above. For example, these programs modules may be implemented using commercially available software tools, using custom object-oriented code written in the C++programming language, using applets or scripts written in the Java programming language, or may be implemented with discrete electrical components or as one or more hardwired application specific integrated circuits (ASIC) that are custom designed for this purpose.

Other embodiments may be apparent to those skilled in the art from consideration and practice of the disclosure. For example, it is contemplated that the user of interactive toy 108 may be able to create a playlist, as discussed above. For example, interactive toy 108 may include a display (not shown). Upon connecting interactive toy 108 to client 104, the user of interactive toy 108 may use the display on interactive toy 108 to navigate through the library on client 104 and to select media content items to be added to a playlist and transferred to interactive toy 108 by applying input to interactive toy 108. Alternatively or additionally, interactive toy 108 may be similarly configured to communicate directly with server 102 via network 106 (i.e., without client 104), and the user of interactive toy 108 may be able to select media content items for a playlist directly from the library on server 102. Further, the announcements discussed above may be visually conveyed to the user of interactive toy 108 through the display.

It is intended that the specification and examples be considered as exemplary only, with a true scope and spirit of the disclosure being indicated by the following claims.

We claim:

1. A media player device, comprising:
at least one input device configured to receive input from a user of the media player device and to generate a signal indicative of the input;
a communication interface configured to selectively connect the media player device to a device separate from the media player device; a
a processor in communication with the at least one input device and the communication interface, the processor being configured to:
establish a communication channel between the media player device and the separate device when the media player device is selectively connected to the separate device;
receive at least one selected media content item from the separate device through the communication channel;
present an announcement describing content of the at least one selected media content item;
prompt a user of the media content device to select whether to execute the at least one selected media content item;
receive input, via the at least one input device, indicating whether to execute the at least one selected media content item; and
execute the at least one selected media content item when the input indicates that the at least one media content item is to be played.

2. The media player device of claim 1, wherein:
the at least one selected media content item is selectable by at least one of a user of the separate device and a user of the media player device,
the announcement includes at least one supplemental media content item associated with the at least one selected media content item based on metadata describing the content of the at least one selected media content item, and
presenting an announcement includes executing the at least one supplemental media content item.

3. The media player device of claim 2, wherein the at least one selected media content item and the at least one supplemental media content item include one of an audio file, a video file, an audio-video file, and an application.

4. The media player device of claim 1, wherein the input includes at least one of tactile input and vocal input.

5. The media player device of claim 1, further including a speaker in communication with the processor, wherein the presenting of the announcement and the prompting are audibly provided via the speaker.

6. The media player device of claim 1, further including a timing device in communication with the processor and configured to generate a signal indicative of a time measurement, wherein the presentation of the announcement and the prompting are in response to the signal.

7. The media player device of claim 1, wherein the media player device is associated with a plush body.

8. A method of navigating media content, comprising:
receiving, by a media player device, at least one selected media content item from a device separate from the media playing device;
presenting, by the media player device, an announcement describing content of the at least one selected media content item;
prompting a user of the media player device to select whether to execute the at least one selected media content item;
receiving, by the media player device, input indicating whether to execute the at least one selected media content item; and
executing, by the media player device, the at least one selected media content item when the input indicates that the at least one selected media content item is to be executed.

9. The method of claim 8, wherein:
the at least one selected media content item is selectable by at least one of a user of the separate device and a user of the media player device,
the announcement includes at least one supplemental media content item associated with the at least one selected media content item based on metadata describing the content of the at least one selected media content item, and
presenting an announcement includes executing, by the media player device, the at least one supplemental media content item.

10. The method of claim 9, wherein the at least one selected media content item and the at least one supplemental media content item include one of an audio file, a video file, an audio-video file, and an application.

11. The method of claim 8, wherein the input includes at least one of tactile input and vocal input.

12. The method of claim 8, wherein the presenting of the announcement and the prompting are audible.

13. The method of claim 8, wherein the presenting of the announcement and the prompting are response to a time determination.

14. A computing system, comprising:
at least one input device;
a processor in communication with the at least one input device, the processor being configured to:
receive, via the at least one input device, a selection of at least one of media content item;
identify at least one supplemental media content item associated with the selected at least one media content item, the supplemental media content item including an announcement describing content of the at least one media content item; and
create a playlist containing the selected at least one media content item and the identified at least one supplemental media content item.

15. The computing system of claim 14, wherein the identified at least one supplemental media content item is identified based on metadata describing the content of the selected at least one media content item.

16. The computing system of claim 15, wherein the computing system is in communication with a server via a network, and the processor further receives the selected at least one media content item and the identified at least one supplemental media content item from the server.

17. The computing system of claim 14, further including a peripheral interface device to communicatively connect a media player device to the computing system via a data link, wherein the processor is configured to transfer the playlist to the media player device via the data link.

18. The computing system of claim 14, wherein the identified at least one supplemental media content item and the selected at least one media content item include at least one of an audio file, a video file, an audio-video file, and an application.

19. A computer-implemented method of managing media content, comprising:
receiving a selection of at least one media content item;
identifying at least one supplemental media content item associated with the selected at least one media content item, the supplemental media content item including an announcement describing content of the selected at least one media content item; and
creating a playlist containing the selected at least one media content item and the identified at least one supplemental media content item.

20. The method of claim 19, wherein the identified at least one supplemental media content item is identified based on metadata describing content of the selected at least one media content item.

21. The method of claim 19, further including transferring the playlist to a media player device.

22. The method of claim 19, wherein the identified at least one supplemental media content item includes an audio file and the selected at least one media content item include at least one of an audio file, a video file, an audio-video file, and an application.

23. The method of claim 19, wherein the selected at least one media content item and the identified at least one supplemental media content are received from a server via a network.

24. A toy, comprising:
a plush body;
an internal processor associated with the plush body;
a memory device associated with the plush body and configured to communicate with the internal processor and to store a plurality of media content items, the plurality of media content items including at least a first media content item and a second media content item;
an audio speaker associated with the plush body and configured to generate sound as a result of signals from the internal processor;
an input device associated with the plush body configured to receive input from a user of the toy and to generate a corresponding input signal;
a communication interface associated with the internal processor and configured to selectively connect the internal processor to an external device outside of the plush body;
an application associated with the internal processor for receiving media content items from the external device and for storing the received media content items in the memory device;
an application associated with the internal processor for providing an audible message for announcement to the user of the toy through the audio speaker, the audible message prompting the user of the toy to select the first media content item;
an application associated with the internal processor for receiving input through the input device indicative of the user of the toy's selection of the first media content item; and
an application associated with the internal processor for providing an audible message for announcement to the user of the toy through the audio speaker, the audible message prompting the user of the toy to select the second media content item when the first media content item is not selected.
